(19) United States
(12) Patent Application Publication
(10) Pub. No.: US 2025/0155853 A1
(43) Pub. Date: May 15, 2025

(54) Method and Device for Parameterizing a Production Process

(71) Applicant: Robert Bosch GmbH, Stuttgart (DE)

(72) Inventors: Simon Baeuerle, Tuebingen (DE); Damir Shakirov, Niefern-Oeschelbronn (DE); Andreas Steimer, Schoemberg (DE)

(21) Appl. No.: 18/833,345

(22) PCT Filed: Jan. 23, 2023
(86) PCT No.: PCT/EP2023/051519

§ 371 Date: Jul. 25, 2024

(30) Foreign Application Priority Data
Jan. 28, 2022 (DE) 10 2022 200 946.0

(51) Int. Cl. G05B 13/04; G05B 13/02

(52) U.S. Cl. CPC G05B 13/042; G05B 13/027; G05B 13/041

(57) ABSTRACT

A method is for providing a process parameter model for parameterizing one or more process steps of a production process for manufacturing a component includes providing a quality model for determining a quality. The quality model is configured to specify the quality of the resulting component directly or with the aid of a predefined quality function based on one or more predefined measurement variables and/or one or more predefined state variables, which each specify a property of a pre-product or intermediate product of the component being manufactured and/or a production device for performing a process step and/or at least one environmental condition, and based on one or more process parameters which control a corresponding one of the process steps. The method further includes training a data-based process parameter model to output one or more process parameters based on one or more measurement variables captured by a sensor.

### TECHNICAL FIELD

The invention relates to production processes with one or more process steps for manufacturing a component. The invention further relates to methods for adjusting the one or more process steps to increase the quality of the manufactured component.

### TECHNICAL BACKGROUND

During the manufacture of components, production processes are typically used to create the product to be manufactured from one or more pre-products by machining or processing. The production processes used can typically be performed in many different ways and are typically set by process parameters. These process parameters typically specify a constant control or variable control or, in the case of control system, control parameters in order to control the tool in the production process with a corresponding manipulated variable. In a control system, a control of a machining tool is coupled to a manufacturing progress.

### DISCLOSURE OF THE INVENTION

According to the present invention, a method for parameterizing a production process for manufacturing a component according to claim 1, as well as a device and a manufacturing arrangement according to the independent claims is provided.

Further embodiments are specified in the dependent claims.

According to a first aspect, a computer-implemented method for providing a process parameter model for parameterizing one or multiple process steps of a production process for manufacturing or machining a component is provided, the method having the following steps:
providing a quality model for determining a quality, wherein the quality model is designed to specify the quality of the resulting component directly or with the aid of a predefined quality function on the basis of one or more predefined measurement variables and/or one or more predefined state variables, which each specify a property of at least one pre-product or of the component being manufactured and/or a production device for performing a process step and/or at least one environmental condition, and on the basis of one or more process parameters which control a corresponding one of the process steps;
training a data-based process parameter model to output one or more process parameters on the basis of one or more measurement variables captured by a sensor and/or one or more predefined state variables by optimizing the quality.

In order to manufacture a component, one or more successively performed process steps are typically used in which one or more pre-products or the semi-manufactured component are respectively machined or processed in the current production state. The machining and processing is carried out in each process step with production devices.

The process step performed by a production device may be controlled with one or more process parameters. On the one hand, the process parameters may specify specific control variables, such as a current of an electric servomotor, an opening angle of a valve, an intensity of a laser beam, a pressing force, and the like.

It may be provided that the process parameters comprise a constant control variable for a process step, a time course of a control variable for a process step, a control parameter of a control for a process step, and/or a target manipulated variable for control for a process step.

Accordingly, such a process parameter may be specified as a constant control variable or a time curve of a control variable with respect to the same physical variable. Furthermore, process parameters may also comprise control parameters of a control in order to achieve an optimal control behavior for manipulated variables to be controlled.

The goal is to adapt the process parameters as optimally as possible to the current state of the component or its pre-product(s) to environmental conditions and to the states of the one or more production devices. These are typically provided on the basis of one or more measurement variables captured by a sensor and/or one or more otherwise predefined state variables.

The process parameters are not easily adjustable, particularly for complex processes or several consecutive process steps, due to the many influencing factors and interactions. In addition, physical modeling with the aid of a physically motivated model is often not readily possible due to the complexity of the individual process steps. In order to achieve an optimum quality of the component, it is necessary to coordinate the process parameters with each other, particularly in the case of a large number of process steps. The previous approach of having experts perform the process modeling and the controller design is complex and not reproducible.

The process parameters, be they control variables, temporal control variable curves or control parameters for controls executed in the production process for machining the component, can be optimized in an automated manner in accordance with the above method. To this end, the process parameters are mapped to one or more process parameters on the basis of least one measurement variable, which comprises a measurable state of the component, the environment and/or the relevant production device and/or on the basis of at least one state variable which comprises a predefined state of the component, the environment and/or the relevant production device.

The at least one process parameter is determined with the aid of a data-based process parameter model that is trained to map the at least one measurement variable and/or the at least one state variable to the corresponding at least one process parameter.

Training a data-based model typically requires training data that assigns a training data point to one or more corresponding labels in the form of process parameters, for example.

One fundamental difficulty lies in optimally specifying the process parameters required for the optimized performance of one or more process steps as labels for the various initial situations with regard to the properties/state of the component/pre-products to be processed, the properties/state of the production device and the environmental conditions. Determining such process parameters for a certain initial situation would be complex and a variety of training data sets for different initial situations are necessary for comprehensive training of the data-based model.

In this regard, the above method provides for creating the process parameter model with the aid of a quality model. The data-based process parameter model is trained on the basis of the quality model. To this end, the quality model maps the at least one measurement variable and/or the at least one state variable that describe or characterize the initial situation for the component to be manufactured and the at least one process parameter, which specifies the manner in which the production process is to be performed, to a component quality.

According to one embodiment, the quality model can comprise a data-based model, wherein training datasets are determined to train the quality model, wherein the training datasets are determined by training data points, which are determined by varying values of the one or more measurement variables and/or one or more state variables and varying values of the process parameters within respectively predefined allowable value ranges, with respectively assigned qualities as labels, the qualities resulting in each case from at least one property of the manufactured component and/or costs of the production process with the aid of a quality function, wherein the quality model is trained with the training datasets.

According to a further embodiment, the quality model can comprise a data-based model, wherein training datasets are determined to train the quality model, wherein the training datasets are determined by training data points, which are determined by varying values of the one or more measurement variables and/or one or more state variables and varying values of the process parameters within respectively predefined allowable value ranges, each assigned with at least one property of the manufactured component and/or costs of the production process as labels, from which the quality can be determined with the aid of a quality function, wherein the quality model is trained with the training datasets.

The quality model can comprise a physical model, a heuristics or data-based model and is configured to evaluate properties of the manufactured component and/or costs of the production process on the basis of an initial situation, which is specified by the at least one measurement variable and/or the at least one state variable and the at least one process parameter, which characterizes the performance of the production process, to evaluate properties of the manufactured component and/or costs of the manufacturing process, wherein the quality is determined with the aid of the quality function with respect to the properties of the manufactured component and/or the costs of the production process.

Thus, a quality model may generally be utilized to determine the quality, which may be formed as a physical model, a heuristics, or a data-based model. The quality model may directly evaluate the quality depending on the initial situation, which is specified by the at least one measurement variable and/or the at least one state variable and the at least one process parameter that characterizes the performance of the production process. Alternatively, the quality may evaluate properties of the manufactured component and costs of the production process according to a quality function. The properties of the manufactured component and/or the costs of the production process are provided accordingly by the quality model. The properties of the manufactured component include, for example, geometric dimensions along with dimensional tolerances, surface conditions of the manufactured component, electrical properties of the manufactured component, robustness of the manufactured component, and the like. Regarding the costs of the production process, the wear of a tool, duration of the production process, energy consumption and material costs are all factors to be considered.

The quality model may also be configured as a data-based model, e.g., in the form of a neural network, and trained appropriately prior to use and creation of the process parameter model. In particular, the training of the data-based quality model may be based on simulations and/or measurements, wherein the initial situation and the resulting quality or the initial situation and one or more component properties of the component determined by the initial situation each determine a training dataset.

The quality model is now trained based on the training datasets. If the quality model is trained on outputting component properties, a resulting quality may be determined with the aid of a predefined quality function. The quality function is substantially definable based on the above properties of the component.

If the quality model is appropriately trained or otherwise predefined, it may be used as the basis for training the process parameter model. The quality model is preferably configured to be differentiated so that training of the data-based process parameter model can be carried out based on the quality. In other words, the loss function for training the process parameter model corresponds to a maximization of the quality, such that training of the data-based process parameter model can be easily achieved in this way.

It may be provided that training data points are used by varying the one or more measurement variables and/or the one or more predefined state variables within their respective value ranges to train the data-based process parameter model on the basis of a loss function which is determined by the quality resulting from the application of the quality model.

By linking the quality model with the process parameter model, the process parameter model can be easily trained. During the training, the at least one measurement variable and/or the at least one state variable are varied within their respective possible value ranges, in order to take into account possible combinations of one or more properties/states of the component or its pre-product(s), one or more properties/states of the production device and/or one or more environmental conditions.

The above procedure makes it possible to create a process parameter model that takes into account very complex relationships in one or between several process steps of a production process and thereby optimizes the quality of a component as the resulting final product by specifying at least one process parameter. Utilizing the quality model and, where appropriate, the quality function to train the process parameter model makes it possible to extract knowledge from data without having to understand the underlying physical models. Due to the high error tolerance when training data-based models, it is also possible to take into account noisy measurement variables and state variables, which often lead to deviations in the process parameters to be determined in physically motivated models and would impair product quality of the manufactured component.

The process parameter model may be used prior to production of a component in order to parameterize the one or more process steps, in particular on the basis of at least one measurement variable of a property captured by a sensor or state of one or more precursor products, a property or state of one or more production devices for the one or more process steps and/or one or more environmental conditions with the aid of the trained process parameter model. After parameterizing the one or more process steps, the component to be manufactured can be produced by performing the parameterized process steps.

### BRIEF DESCRIPTION OF THE DRAWINGS

Preferred embodiments are described in more detail below with reference to the accompanying drawings. Shown are:

FIG. 1 a schematic illustration of a production process for manufacturing a component;

FIG. 2 a block diagram of a system for providing a process parameter model for performing the production process of FIG. 1; and

FIG. 3 a flowchart illustrating a method for providing a process parameter model.

### DESCRIPTION OF EMBODIMENTS

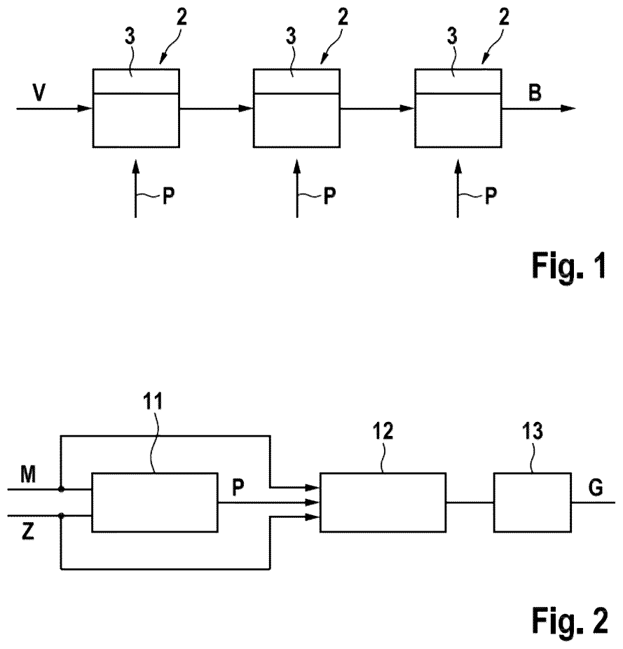

FIG. 1 schematically shows a production process 1 with a number of consecutive process steps 2 for manufacturing or further processing a product. The process steps 2 serve to successively machine or process one or more pre-products V in order to obtain a component B. For this purpose, at least one production device 3 is provided for each of the process steps 2, which is provided with a tool or other device for machining or processing the component B.

The component B may be a shaped component, an electronic component, an assembly, a group having component assemblies, or a finished product. The pre-products V are corresponding workpiece blanks, individual parts that are assembled by the process steps 2, such as electronic components, and a printed circuit board in a process for creating a populated printed circuit board, an integrated component and a lead frame and a housing mold for manufacturing a housed integrated circuit, and the like.

The process steps may include a variety of machining and processing steps, such as all types of mechanical machining such as drilling, turning, milling, grinding, cutting, punching, sawing, and the like, connection techniques such as gluing, bonding, welding, laser welding, and the like, joining techniques, thermal treatments, surface treatments, chemical treatments, contacting techniques, such as bonding, and the like.

The production process 1 comprises one or more process steps 2, which successively produce the finished component from one or more pre-products. Each of the process steps 2 is controlled by one or more process parameters P. Process parameters P are herein understood to mean parameters that may be specified for the execution of a machine, thermal or chemical process in order to be able to affect at least one property of the component B to be manufactured. Each of the process steps 2 may be characterized by one or more process parameters P, such as temperatures, supplied powers, tool or workpiece, speeds or rotational speeds, or also target specifications for a control of a machine process, and the like.

The process parameters P may generally comprise control variables for the machining and processing techniques. The control variables may be specified constantly or also define varying courses of a process parameter, which may be parameterized as such. For example, chronological curves of a model parameter may be specified by a plurality of sub-parameters in the form of time periods and corresponding gradients of the relevant process parameter P provided within the time periods. The sub-parameters and the process parameters P are subsequently further referred to as process parameters P.

The control variables may also comprise a target specification for a control of a manipulated variable of a production device 3 that is used to guide a tool or other device. Furthermore, the process parameters P may comprise one or more control parameters of a control to parameterize a corresponding control for one or more manipulated variables. Such a control system may include a PID controller, state controller, adaptive controller, model-based predictive controller, or the like.

When manufacturing a component, one or more process parameters are specified and the component is manufactured accordingly while maintaining the relevant process parameters P.

FIG. 2 schematically shows a system for providing a process parameter model 11 with which the individual process steps 2 and the production devices 3 associated with the process steps can be pre-set to produce a component B from one or more pre-products V. In FIG. 2, a process parameter model 11 is initially provided, which is to determine one or more process parameters P in the trained state from one or more measurement variables M and one or more state variables Z.

The process parameter model 11 is preferably configured as a data-based model and in particular provided as a deep neural network. The measurement variables may correspond to variables captured by a sensor and may specify material properties, geometrical properties, chemical properties and characteristics of the one or more pre-products. The state variables may specify the states of the pre-products (materials or material parameters) and/or the production devices (such as default settings or properties the production devices that are known in advance without measurement) and environmental conditions. Overall, the measurement variables and state variables provide a description of the system state prior to the start of the production process.

If the process parameter model 11 has been trained, the output-side process parameters P are optimized for controlling the individual process steps 2 of the production process 1.

For the training of the process parameter model 11, this is coupled on the output side with a quality model 12, which maps the one or more measurement variables M, the one or more state variables Z and the resulting model parameters to a quality G of the resulting manufactured component B. The quality model can be configured in a variety of ways depending on the component to be manufactured and the processes used. For example, the quality model 12 may comprise a physically motivated model, a heuristic model, or a data-based model. The quality G corresponds to an evaluation of the quality of the manufactured component and/or the cost of the production process.

The quality of the manufactured component is characterized by its properties or usability for the intended use, and may include: manufacturing tolerances, dimensions, a surface quality, a robustness, and the like. For example, the costs of the manufacturing process may account for the material usage, the duration of the production process, the energy consumption and wear of the production devices 3.

The quality may be provided directly by the quality model 12 or determined with the aid of a quality function 13, which typically combines one or more properties of the manufactured component and/or the costs of the production process quantified in an evaluation measure of the quality G.

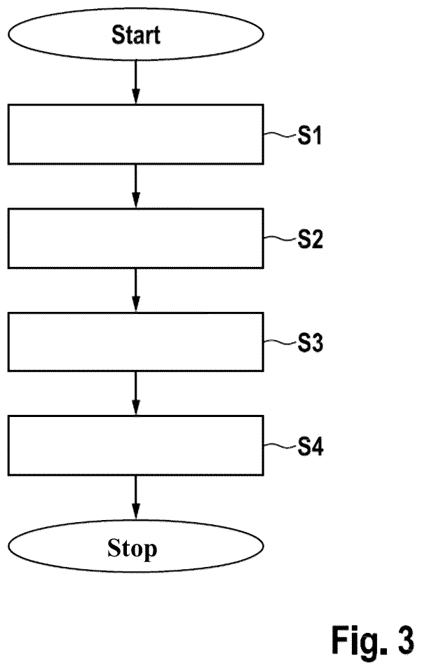

FIG. 3 shows a flow chart for illustrating a method by which the process parameter model 11 can be created according to the function shown in FIG. 2. The method is computer-implemented and serves to easily optimize the process parameter model 11 without expert knowledge.

The core of the method is the linking of process parameter model 11 with the quality model 12.

To this end, in step S1, a production process 1 is first defined, which comprises a series of process steps 2, which can each be parameterized by one or more process parameters P, as described in connection with FIG. 1.

With the aid of a suitable simulation model, a heuristic or from measurement values, properties of the component manufactured in this way and/or the costs of the production process can be evaluated based on real or virtual process specifications, namely specific values for the one or more measurement variables M, for the one or more state variables Z and for possible process parameters P.

The evaluation may be made based on actual production of a component and a subsequent measurement or assessment of the manufactured component and/or a determination of the costs of the production process, taking into account the duration of the production process, the wear, the cost of material, and the energy consumption. According to the specified quality function 13, this results in a quality G in each case. The process specifications M, Z, P and the quality as a label define training data sets in step S2. To determine training data sets, the process specifications M, Z, P are varied and the corresponding resulting quality G is determined as the label. The process specifications are varied such that the input data space for the quality model is mapped as completely as possible. Alternatively, the process specifications may also be varied based on domain knowledge.

In this way, the training data points are labeled and trained for the realistic value ranges of the one or more measurement variables, the one or more state variables and the one or more model parameters that are realistic in practice.

The training datasets may be used in step S3 to parameterize a physical quality model 12 or to train a data-based quality model 12. Alternatively, the quality G may also result directly by applying a heuristic from the corresponding process specifications M, Z, P.

A deep neural network is used as a data-based quality model 12, which can be trained in a manner known with the aid of a gradient-based method. The data-based quality model 12 can in particular be trained with qualities G resulting from measurement or simulation methods relating to the component B to be manufactured or manufactured. This results in a data-based quality model 12, which can reliably determine a quality G of the resulting component B in a large input data space. The quality model 12 is preferably selected such that it is distinguishable, so that the resulting quality G can be used in a loss term for training the process parameter model 11. In particular, the quality G can be taken into account directly as a loss or a reciprocal value of the quality G as a loss.

A heuristic can combine the corresponding process specifications M, Z, P in a control-based manner in order to directly obtain a quality G of the component B to be manufactured.

In step S4, the process parameter model 11 is trained in an appropriate manner by varying input parameters for the process parameter model 11, wherein the one or more measurement variables M and the one or more state variables Z are each varied in their entire value range in order to completely cover the input data space for the process parameter model 11. This results in process parameters P, which together with the one or more measurement variables M and the one or more state variables Z, define the process specifications and are evaluated by the quality model 12 and, if necessary, by the quality function 13.

The resulting quality G now provides the loss for the training of the network parameters of the data-based process parameter model 11. This loss can be utilized in a manner known in itself as part of a gradient based training process. Based on these, the process parameter model 11 can be trained in an automated manner with the aid of an evaluation by the quality model 12 based on a large number of measurement variables M and/or state variables Z that vary through combination.

The process parameter model 11 modeled in this way may now be used for the production process described above. To this end, the measurement variables M and the state variables Z are recorded before the start of the manufacture of a component B and the corresponding process parameters P are determined with the aid of the process parameter model. These process parameters P are now implemented in the production devices 3 of the individual process steps.

A bonding process of a bonded wire to a contact surface may be specified as an example of a production process. In the bonding process, a bonded wire is pushed onto a surface of the contact surface using an ultrasonic head. The bond wire bonds with the surface due to the pressing force and the transmitted vibrations. For example, electronic components may be electrically connected to the printed circuit board. With respect to the above definitions, the measurement variables correspond to a surface roughness, a contamination and the like, the condition variables correspond to a material, a component geometry (with regard to possible vibrations and resonances), the process parameters correspond to a pressing force, a bond duration, an ultrasonic amplitude and the quality corresponds to an evaluation measure that takes into account a bond cross-section, which has a significant influence on load-bearing capacity of the bond, and a deformation of the bond wire.

As another example of a production process, a laser welding process may be specified. Laser welding uses a focused laser beam to melt metal locally. Two joining partners are fixedly connected to each other by the molten metal. The laser beam is either absorbed (taken up) or reflected by the metal. Only the absorbed power is available for melting.

With reference to the above definitions, the measurement variables may have an absorptivity of a surface, a surface roughness, a contamination and the like, the state variables a specification of a workpiece material (e.g. copper/aluminum/alloy type), a component geometry, a type of laser welding machine, a type of laser optics, the process parameters have a wavelength of the laser, a focus diameter, a laser power, a feed rate and the like, and the quality comprises an evaluation measure that takes into account a mechanical load capacity of the seam, a flatness of the seam, a weld depth, a process stability (amount and size of weld spatter, pores or apertures), and the like.

Another example of a production process is a semiconductor production process. In semiconductor manufacturing, many individual process steps are interlinked. There are a variety of relevant quantities, wherein the specific connections are not always immediately tangible. In a process step, the wafer (the semiconductor component) is provided with a coating. With respect to the above definitions, the measurement variables may include a wafer state (e.g. defect density, in-line measurements from previous processes, e.g. measurement of layer thicknesses) and the like, the state variables may include a specification of a state of the chambers (number of operating hours) and the like, the process parameters may include a storage temperature, O2 quantity, an amount of etching agent, a performance of the chemical vapor deposition (CVD), physical vapor deposition (PVD) or spin coating processes and the like, and the quality may include an evaluation measure which takes into account a coating thickness, an edge slope of the coating after etching, a dimensional accuracy after coating processing, and the like.

1. A computer-implemented method for providing a process parameter model for parameterizing one or more process steps of a production process for manufacturing a component, the method comprising:
providing a quality model for determining a quality, the quality model configured to specify the quality of the resulting component directly or with the aid of a predefined quality function based on one or more predefined measurement variables (M) and/or one or more predefined state variables, which each specify a property of a pre-product or intermediate product of the component being manufactured and/or a production device for performing a process step and/or at least one environmental condition, and based on one or more process parameters which control a corresponding one of the process steps;
training a data-based process parameter model to output one or more process parameters based on one or more measurement variables captured by a sensor and/or one or more predefined state variables by optimizing the quality.

2. The method according to claim 1, wherein the process parameters comprise a constant control variable for a process step, a time course of a control variable for a process step, a control parameter of a control for a process step, and/or a target manipulated variable for control for a process step.

3. The method according to claim 1, wherein:
the quality model comprises a physical model, a heuristic or data-based model and is configured to evaluate properties of the manufactured component and/or costs of the production process based on an initial situation, which is specified by the at least one measurement variable and/or the at least one state variable and the at least one process parameter, which characterizes the performance of the production process, to evaluate properties of the manufactured component and/or costs of the production process, and
the quality is determined with the aid of the quality function with respect to the properties of the manufactured component and/or the costs of the production process.

4. The method according to claim 1, wherein:
the quality model comprises a data-based model,
training datasets are determined to train the quality model,
the training datasets are determined by training data points, which are determined by varying values of the one or more measurement variables and/or one or more state variables and varying values of the process parameters within respectively predefined allowable value ranges, with respectively assigned qualities as labels, the qualities resulting in each case from at least one property of the manufactured component and/or costs of the production process with the aid of the quality function, and
the quality model is trained with the training datasets.

5. The method according to claim 1, wherein:
the quality model comprises a data-based model,
training datasets are determined to train the quality model,
the training datasets are determined by training data points, which are determined by varying values of the one or more measurement variables and/or one or more state variables and varying values of the process parameters within respectively predefined allowable value ranges, each assigned with at least one property of the manufactured component and/or costs of the production process as labels, from which the quality can be determined with the aid of the quality function, and
the quality model is trained with the training datasets.

6. The method according to claim 3, wherein:
the properties of the manufactured component have geometric dimensions along with dimensional tolerances, a surface quality of the manufactured component, an electrical property of the manufactured component and a robustness of the manufactured component, and
the cost of the production process includes wear of a tool, a duration of the production process, comprises an energy expenditure of the production process and a material expenditure.

7. The method according to claim 1, wherein training data points are used by varying the one or more measurement variables and/or the one or more predefined state variables within their respective value ranges to train the data-based process parameter model based on a loss function which is determined by the quality resulting from the application of the quality model.

8. The method according to claim 1, wherein the process parameter model is used prior to production of a component in order to parameterize the one or more process steps, based on at least one measurement variable of a property captured by a sensor or state of one or more pre-products, a property or state of one or more production devices for the one or more process steps and/or one or more environmental conditions with the aid of the trained process parameter model.

9. A device for performing the method according to claim 1.

10. The method according to claim 1, wherein a computer program product comprises instructions which, when the computer program product is executed by at least one data processing device, cause the data processing device to perform the method.

11. A non-transitory machine-readable storage medium comprising instructions which, when executed by at least one data processing device, cause the data processing device to perform the method according to claim 1.
